(19) United States
(12) Patent Application Publication
(10) Pub. No.: US 2026/0339045 A1
(43) Pub. Date: Oct. 29, 2026

(54) OPTICAL MODULE AND METHOD FOR FORMING THE SAME

(71) Applicant: AuthenX Inc., Zhubei City (TW)

(72) Inventors: Sheng-Fu LIN, Zhubei City (TW); Po-Kuan SHEN, Zhubei City (TW); Jenq-Yang CHANG, Zhubei City (TW); Mao-Jen WU, Zhubei City (TW)

(73) Assignee: AuthenX Inc., Zhubei City (TW)

(21) Appl. No.: 19/655,974

(22) Filed: Apr. 23, 2026

Related U.S. Application Data
(60) Provisional application No. 63/795,119, filed on Apr. 25, 2025.
(60) Provisional application No. 63/827,476, filed on Jun. 20, 2025.

(51) Int. Cl. G02B 6/42; B82Y 20/00; B82Y 40/00; G02B 1/00

(52) U.S. Cl. CPC G02B 6/4206; B82Y 20/00; B82Y 40/00; G02B 1/002

(57) ABSTRACT

An optical module includes a substrate structure and a meta-lens. The substrate structure includes an optical waveguide. The meta-lens is over the substrate structure. The meta-lens includes a dielectric structure and a plurality of meta-atoms. The dielectric structure is over the substrate structure. The meta-atoms are within the dielectric structure and each of the meta-atoms includes a first portion and a second portion over the first portion. An orthographic projection area of the second portion onto the substrate structure at least partially overlaps with an orthographic projection area of the first portion onto the substrate structure. The meta-lens is configured to receive an optical signal from the optical waveguide.

### CROSS-REFERENCE TO RELATED APPLICATION

This application claims priority to US Provisional Application Serial Number 63/795,119, filed Apr. 25, 2025, and US Provisional Application Serial Number 63/827,476, filed Jun. 20, 2025, the disclosures of which are incorporated herein by reference in their entireties.

### BACKGROUND

### Field of Invention

The present disclosure relates to an optical module and a method for forming the same.

### Description of Related Art

With advancements in manufacturing technology, the demands for data transmission and computing speed are increasing, presenting semiconductor manufacturing processes with the challenge of integrating more complex circuits into a unit area. Silicon photonics technology has become a focal point of the field of optoelectronic integration due to its advantages, such as high bandwidth, low power consumption, and compatibility with CMOS processes, etc. However, there are significant differences in the size and distribution between the beams transmitted by silicon photonic circuits and optical fibers, resulting in extremely high optical losses when they are directly coupled.

In order to improve coupling efficiency, meta-lenses with subwavelength structures are used for beam focusing. Among them, meta-lens structure designs with high aspect ratios can further extend the phase modulation range and improve optical efficiency. However, the integration of meta-lenses with silicon photonic chip or fiber array unit (FAU) requires sub-micron level alignment accuracy, and both process tolerances and packaging displacements can cause optical axis misalignments, thus reducing the yield of the optical module. Therefore, how to stably produce meta-lens structures with high aspect ratios and accurately align and couple them to the silicon photonic chip or fiber array unit has gradually become a key area where the industry is eager to invest research and development resources.

### SUMMARY

An aspect of the disclosure is to provide an optical module and a method for forming an optical module that may efficiently solve the aforementioned problems.

According to an embodiment of the disclosure, an optical module is provided. The optical module includes a substrate structure and a meta-lens. The substrate structure includes an optical waveguide. The meta-lens is over the substrate structure. The meta-lens includes a dielectric structure and a plurality of meta-atoms. The dielectric structure is over the substrate structure. The meta-atoms are within the dielectric structure, and each of the meta-atoms includes a first portion and a second portion over the first portion. An orthographic projection area of the second portion onto the substrate structure at least partially overlaps with an orthographic projection area of the first portion onto the substrate structure. The meta-lens is configured to receive an optical signal from the optical waveguide.

In an embodiment of the disclosure, the dielectric structure includes a first dielectric layer and a second dielectric layer over the first dielectric layer. A top surface of the first dielectric layer is substantially flush with a top surface of the first portion. A top surface of the second dielectric layer is substantially flush with a top surface of the second portion.

In an embodiment of the disclosure, the first dielectric layer and the second dielectric layer include different materials.

In an embodiment of the disclosure, a refractive index of the first dielectric layer is less than a refractive index of the first portion. A refractive index of the second dielectric layer is less than a refractive index of the second portion.

In an embodiment of the disclosure, one of the meta-atoms further includes a residue. The residue is between the first portion and the second portion. The residue includes a same material as the first dielectric layer.

In an embodiment of the disclosure, an overlap ratio of the orthographic projection area of the second portion to the orthographic projection area of the first portion is between about 0.3 and about 1.

In an embodiment of the disclosure, the second portion and the first portion include a material, and a refractive index of the material is between about 1.2 and about 4.

In an embodiment of the disclosure, a cross-sectional area of one of the second portion and the first portion decreases upwards along a direction perpendicular to the substrate structure.

In an embodiment of the disclosure, the substrate structure includes a silicon photonic chip. The silicon photonic chip includes the optical waveguide. The optical waveguide is configured to couple the optical signal to the meta-lens. A core width of the optical waveguide is less than about 150 micrometers. The meta-lens further includes a reflective structure. The reflective structure is over the substrate structure and configured to reflect the optical signal.

In an embodiment of the disclosure, the substrate structure includes a fiber array unit. The fiber array unit includes the optical waveguide. The optical waveguide is configured to couple the optical signal to the meta-lens. A core diameter of the optical waveguide is less than about 150 micrometers. The meta-lens further includes a reflective structure. The reflective structure is over the substrate structure and configured to reflect the optical signal.

In an embodiment of the disclosure, the meta-lens further includes a reflective structure. The reflective structure is between the first portion and the second portion of one of the meta-atoms.

In an embodiment of the disclosure, a lateral feature dimension of at least one of the first portion and the second portion is between about 30 nm and about 450 nm.

In an embodiment of the disclosure, one of the meta-atoms further includes a third portion over the second portion. An orthographic projection area of the third portion onto the substrate structure at least partially overlaps with the orthographic projection area of the second portion onto the substrate structure.

According to another embodiment of the disclosure, a method for forming an optical module is provided. The method includes: depositing a first metamaterial layer over a substrate structure; patterning the first metamaterial layer until the substrate structure is exposed to form a plurality of first portions separated from one another and such that the first portions form a plurality of subwavelength structures; depositing a dielectric material covering the first portions and the substrate structure, in which a refractive index of the dielectric material is less than a refractive index of the first metamaterial layer; performing a planarization process on the dielectric material such that a top surface of the planarized dielectric material is substantially flush with a plurality of top surfaces of the first portions; depositing a second metamaterial layer over the planarized dielectric material; patterning the second metamaterial layer until the dielectric material is exposed to form a plurality of second portions separated from one another and such that the second portions form a plurality of subwavelength structures, in which each of the second portions at least partially overlaps with a corresponding one of the first portions; and forming an optical waveguide, in which the first portions and the second portions are configured to receive an optical signal from the optical waveguide.

In an embodiment of the disclosure, the second portions and the first portions include a material, and a refractive index of the material is between about 1.2 and about 4.

In an embodiment of the disclosure, an orthographic projection area of each of the second portions onto the substrate structure overlaps with an orthographic projection area of the corresponding one of the first portions onto the substrate structure. A ratio of overlap is between about 0.3 and about 1.

In an embodiment of the disclosure, the method further includes forming a reflective structure over one of the second portions.

According to yet another embodiment of the disclosure, a method for forming an optical module is provided. The method includes: depositing a first dielectric material over a substrate structure; patterning the first dielectric material to form a plurality of first trenches exposing the substrate structure; depositing a first metamaterial layer covering the patterned first dielectric material and filling the first trenches; performing a first planarization process on the first metamaterial layer to form a plurality of first portions separated from one another in the first trenches and such that the first portions form a plurality of subwavelength structures, in which a plurality of top surfaces of the first portions are substantially flush with a top surface of the patterned first dielectric material; depositing a second dielectric material over the patterned first dielectric material and the first portions; patterning the second dielectric material to form a plurality of second trenches; depositing a second metamaterial layer covering the patterned second dielectric material and filling the second trenches; performing a second planarization process on the second metamaterial layer to form a plurality of second portions separated from one another in the second trenches and such that the second portions form a plurality of subwavelength structures, and the second portions at least partially overlapping with the first portions; and forming an optical waveguide, in which the first portions and the second portions are configured to receive an optical signal from the optical waveguide.

In an embodiment of the disclosure, the first dielectric material and the second dielectric material include different materials.

In an embodiment of the disclosure, the method further includes: forming a reflective structure over at least one of the first portions after forming the first portions, in which the second dielectric material is deposited covering the reflective structure.

Accordingly, in the optical module and the method for forming the optical module of some embodiments of the present disclosure, the meta-atoms with a high aspect ratio formed by staking different layers can provide a wider range of phase modulation and higher optical efficiency. In addition, by simultaneously configuring the meta-lenses with reflective and transmissive functions in a meta-lens array, during the alignment process, the meta-lenses with the reflective function are used to reflect part of the optical signals from the silicon photonic chip or fiber array unit, and photodetectors are used to measure the intensities of the returned lights to accurately determine the alignment state of the optical axes. As a result, automated sub-micron alignment accuracy can be achieved during the packaging process without the need of external microscopes or manual adjustments. Additionally, the method adopted for forming the optical module can use standard thin film deposition and lithography process, thus possessing high mass production potential and being able to effectively improve the coupling efficiency and packaging reliability of the optical module.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIGS. 1-5 illustrate cross-sectional views of various stages of a method for forming an optical module according to some embodiments of the present disclosure;

FIG. 6A illustrates a cross-sectional view of the optical module taken along line A-A’ in FIG. 5 according to some embodiments of the present disclosure;

FIG. 6B illustrates a cross-sectional view of the optical module taken along line B-B’ in FIG. 5 according to some embodiments of the present disclosure;

FIGS. 7-11 illustrate cross-sectional views of various stages of a method for forming an optical module according to some other embodiments of the present disclosure;

FIGS. 12 and 13 illustrate cross-sectional views of optical modules according to some other embodiments of the present disclosure;

FIG. 14 illustrates a schematic perspective view of an optical module according to some other embodiments of the present disclosure;

FIG. 15 illustrates a cross-sectional view of the optical module taken along line C-C' in FIG. 14 according to some other embodiments of the present disclosure;

FIG. 16 illustrates a schematic perspective view of an optical module according to some other embodiments of the present disclosure;

FIG. 17 illustrates a cross-sectional view of the optical module taken along line D-D' in FIG. 16 according to some other embodiments of the present disclosure; and

FIGS. 18 and 19 illustrate cross-sectional views of optical modules according to some other embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the drawings, the thickness of layers, films, panels, areas, etc., are increased for clarity. Throughout the specification, the same reference numerals will be used to refer to similar components. It will be understood that when an element, such as a layer, film, area or substrate, is referred to as being “above” or “connected to” another element, it can be directly above the other element or connected to the other element or intervening elements may also be present. In contrast, when an element is referred to as being “directly above” another element or “directly connected” to another element, there are no intervening elements present. As used herein, "connection" can refer to physical and/or electrical connection. In addition, "electrical connection" or "coupling" can refer to the presence of other elements between two components.

It will be understood that, although the terms first, second, third, etc. may be used herein to describe various elements, components, areas, layers and/or parts, these elements, components, areas, layers and/or parts should not be limited by these terms. These terms are only used to distinguish one element, component, area, layer or part from another element, component, area, layer or part. Thus, a first element, component, area, layer or part discussed below could be termed a second element, component, area, layer or part without departing from the teachings of the present disclosure.

The terminology used herein is for the purpose of describing particular example embodiments only and is not intended to be limiting to the present disclosure. As used herein, the singular forms “a,” “an,” and “the” are intended to include the plural forms, including “at least one”, unless the context clearly indicates otherwise. “Or” means “and/or.” As used herein, the term “and/or” includes any and all combinations of one or more of the associated listed items. It will be further understood that the terms “comprises” and/or “comprising”, or “includes” and/or “including” or “has” and/or “having” when used in this specification, specify the presence of stated features, areas, integers, steps, operations, elements, and/or components, but do not preclude the presence or addition of one or more other features, areas, integers, steps, operations, elements, components, and/or groups thereof.

As used herein, "about," "approximately," or "substantially" can be used to select a more acceptable deviation range or standard deviation based on optical properties, etching properties or other properties, and one standard deviation does not apply to all properties.

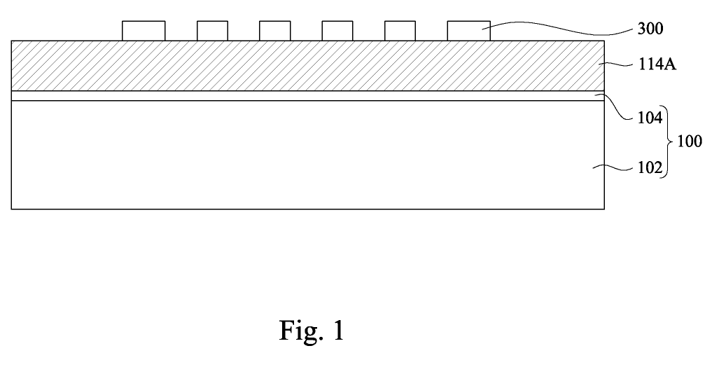

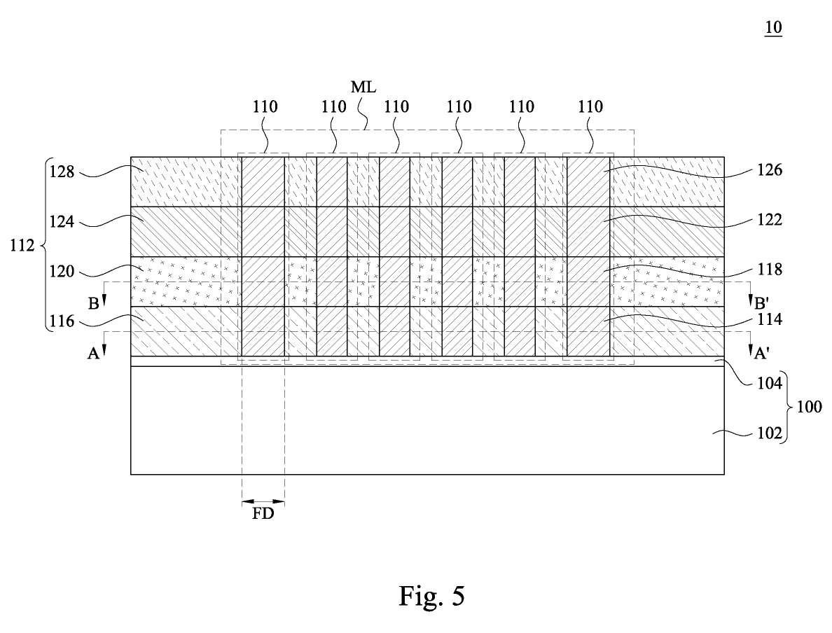

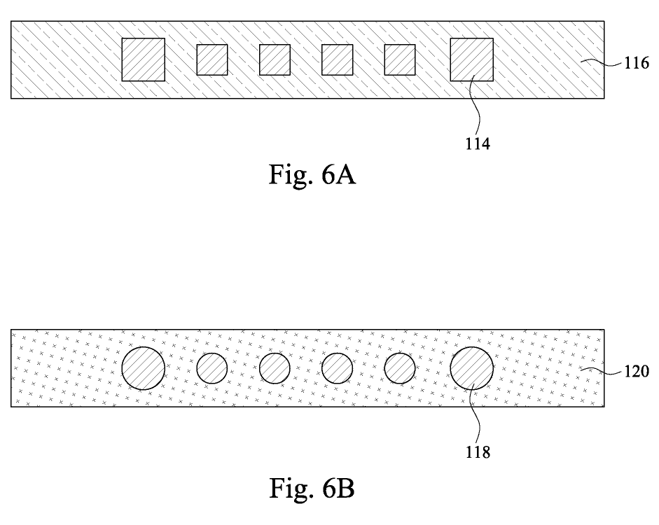

A description is provided with reference to FIGS. 1-6B. FIGS. 1-5 illustrate cross-sectional views of various stages of a method for forming an optical module 10 according to some embodiments of the present disclosure. FIGS. 6A and 6B illustrate cross-sectional views of the optical module 10 taken along line A-A’ and line B-B’ in FIG. 5, respectively.

As shown in FIG. 1, a first metamaterial layer 114A is first deposited over a substrate structure 100. The substrate structure 100 may include a substrate 102. In some embodiments, the substrate 102 may include silicon, glass, optical resin, optical plastic, or a combination thereof.

In some embodiments, the substrate structure 100 may further include an anti-reflective layer 104 over the substrate 102 to reduce interface reflection loss and improve transmission efficiency. The anti-reflective layer 104 may include silicon oxide (SiO), silicon nitride (SiN), titanium oxide (TiO), hafnium oxide (HfO), tantalum oxide (TaO), or a combination thereof.

In some embodiments, the first metamaterial layer 114A may include a material suitable for forming meta-atoms, such as amorphous silicon, polycrystalline silicon, gallium nitride (GaN), titanium oxide (TiO), hafnium oxide (HfO), silicon nitride (SiN), silicon oxide (SiO), or a combination thereof. In some embodiments, a refractive index of the first metamaterial layer 114A is between about 1.2 and about 4. It is noted that the term "metamaterial layer" herein refers to a material layer that will be subsequently formed into a subwavelength geometry structure through various processes to achieve a specific electromagnetic response, so as to realize specific refraction, phase modulation, or polarization control capability.

Then, a mask layer 300 is formed over the first metamaterial layer 114A. The mask layer 300 has a first pattern after being patterned. In some embodiments, the mask layer 300 may be a photoresist or a hard mask. The patterning of the mask layer 300 may be achieved by using lithography, electron-beam lithography, nanoimprint lithography, or other patterning techniques suitable for defining subwavelength features. When the hard mask is used as the mask layer 300, the mask layer 300 may include silicon oxide (SiO), silicon nitride (SiN), or a thin metal film.

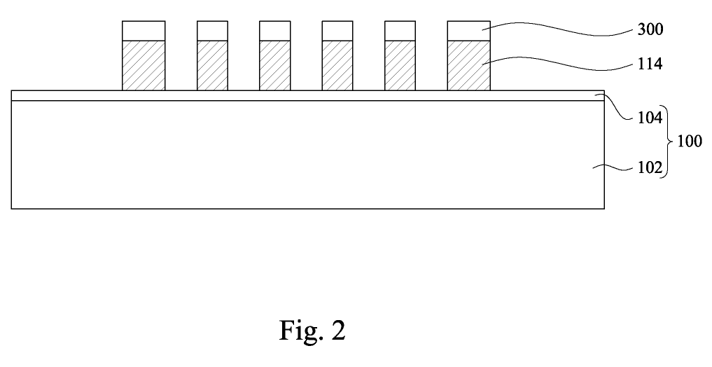

As shown in FIG. 2, a patterning process, such as etching, is performed on the first metamaterial layer 114A through the mask layer 300 until a top surface of the substrate structure 100 is exposed. As a result, the first pattern that the mask layer 300 has is transferred into the first metamaterial layer 114A to form a plurality of first portions 114 separated from one another. These first portions 114 form a plurality of subwavelength structures, and their feature dimensions and periods are both smaller than an operating wavelength of the target incident light. As shown in FIG. 2, the dimensions of these first portions 114 can vary depending on the defined first pattern. For example, a width of the first one of the first portions 114 on the left and a width of the first one of the first portions 114 on the right can be greater than a width of the four first portions 114 in the middle in FIG. 2.

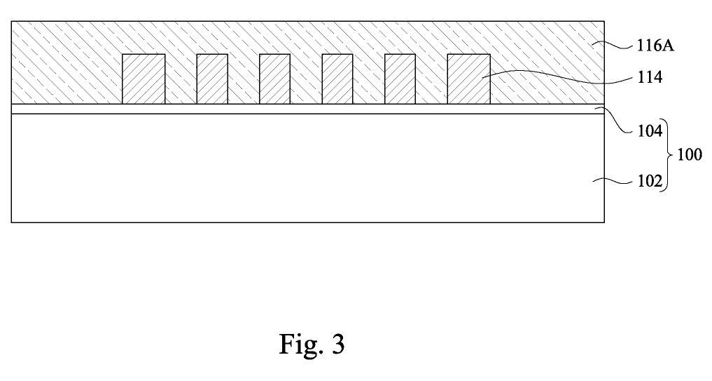

As shown in FIG. 3, the mask layer 300 is removed from the first portions 114 to expose top surfaces of the first portions 114. In some embodiments, depending on the composition of the mask layer 300, the mask layer 300 can be removed by a method, such as ashing, wet etching, or solvent stripping, etc.

Next, a first dielectric material 116A is deposited covering the top surfaces of the first portions 114 and the substrate structure 100. A refractive index of the first dielectric material 116A is less than that of the first portions 114. The first dielectric material 116A may include silicon oxide (SiO), silicon nitride (SiN), titanium oxide (TiO), hafnium oxide (HfO), tantalum oxide (TaO), sol-gel derived material, or a combination thereof. In some embodiments, the refractive index of the first dielectric material 116A is between about 1.2 and about 3.

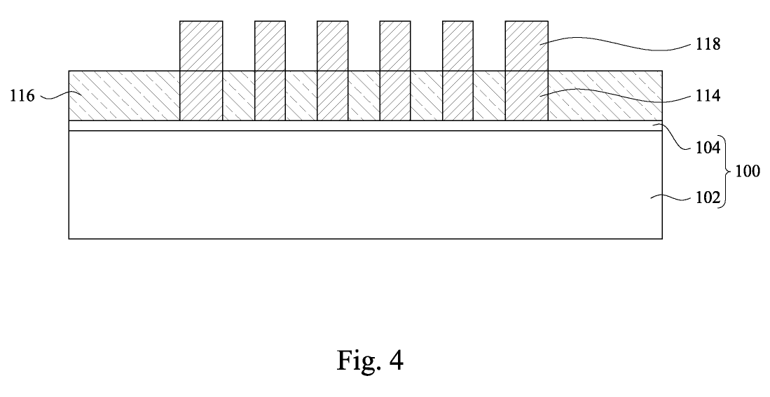

As shown in FIG. 4, a planarization process, such as chemical mechanical polishing (CMP), is performed on the first dielectric material 116A to expose the top surfaces of the first portions 114 so as to form a first dielectric layer 116. The first dielectric layer 116 laterally surrounds the first portions 114. In some embodiments, the planarization process is performed such that a top surface of the first dielectric layer 116 is substantially flush with the top surfaces of the first portions 114.

After that, second portions 118 are formed over the first portions 114. The formation of the second portions 118 can adopt a process similar to that used to form the first portions 114. For example, a second metamaterial layer is deposited over the first portions 114 and the first dielectric layer 116, and a patterning process is performed on the second metamaterial layer through a mask layer until the first dielectric layer 116 is exposed to form the second portions 118 separated from one another. Similarly, these second portions 118 form a plurality of subwavelength structures.

As shown in FIG. 4, the second portions 118 respectively correspond to the first portions 114, and are located vertically above the corresponding first portions 114.

In some embodiments, an orthographic projection area of each of the second portions 118 at least partially overlaps with an orthographic projection area of the corresponding first portion. In greater detail, an overlap ratio between the first portion 114 and the second portion 118 is between about 0.3 and about 1. It is noted that the "orthographic projection area" of an element referred to herein refers to the range covered by the vertical projection of the element onto the substrate structure 100. In addition, the "overlap ratio" between two elements is defined as the ratio of the overlapping area of the orthographic projection areas of the two elements to the orthographic projection area of the lower of the two elements.

For example, as shown in FIG. 4, the orthographic projection area of the second portion 118 substantially overlaps with the orthographic projection area of the first portion 114. In some embodiments, under the circumstance that the first portion 114 and the second portion 118 have the same cross-sectional profile, the overlap ratio between the first portion 114 and the second portion 118 is about 1. In greater detail, the second portion 118 is vertically aligned with the first portion 114. In some embodiments, the second portions 118 may at least partially contact the top surfaces of the first portions 114.

Each of the second portions 118 may include a material the same as or different from the first portion 114. In some embodiments, each of the second portions 118 may include amorphous silicon, polycrystalline silicon, gallium nitride (GaN), titanium oxide (TiO), hafnium oxide (HfO), silicon nitride (SiN), silicon oxide (SiO), or a combination thereof. In some embodiments, each of the second portions 118 includes the material with a refractive index between about 1.2 and about 4. In some embodiments, the previously-mentioned planarization process may generate residues between the first portions 114 and the second portions 118. Each of these residues has a material the same as the first dielectric layer 116.

As shown in FIG. 5, a second dielectric layer 120 is formed over the first portions 114 and the first dielectric layer 116, and laterally surrounds the second portions 118. A top surface of the second dielectric layer 120 is substantially flush with top surfaces of the second portions 118. A refractive index of the second dielectric layer 120 is less than that of the second portions 118. The second dielectric layer 120 may include a material the same as or different from the first dielectric layer 116. In some embodiments, the second dielectric layer 120 may include silicon oxide (SiO), silicon nitride (SiN), titanium oxide (TiO), hafnium oxide (HfO), tantalum oxide (TaO), sol-gel derived material, or a combination thereof. In some embodiments, the second dielectric layer 120 includes the material with a refractive index between about 1.2 and about 3.

Then, third portions 122, a third dielectric layer 124 laterally surrounding the third portions 122, fourth portions 126, and a fourth dielectric layer 128 laterally surrounding the fourth portions 126 are formed by using a similar method. As shown in the figure, the third portions 122 and the fourth portions 126 are stacked vertically above the second portions 118 in sequence. Materials of each of the third portions 122 and each of the fourth portions 126 may be exactly the same as, partially different from, or completely different from the materials of the first portions 114 and the second portions 118. For example, each of the third portions 122 includes the material different from those of the first portions 114 and the second portions 118, while each of the fourth portions 126 includes the material the same as that of the first portions 114. In some embodiments, each of the third portions 122 and each of the fourth portions 126 respectively include the materials with a refractive index between about 1.2 and about 4. Residues may be present between the second portions 118 and the third portions 122, and each of the residues includes a material the same as the second dielectric layer 120. Residues may be present between the third portions 122 and the fourth portions 126, and each of the residues includes a material the same as the third dielectric layer 124.

The third dielectric layer 124 and the fourth dielectric layer 128 are stacked over the second dielectric layer 120 in sequence. A top surface of the third dielectric layer 124 is substantially flush with top surfaces of the third portions 122. A refractive index of the third dielectric layer 124 is less than that of the third portions 122. A top surface of the fourth dielectric layer 128 is substantially flush with top surfaces of the fourth portions 126. A refractive index of the fourth dielectric layer 128 is less than that of the fourth portions 126. Materials of the third dielectric layer 124 and the fourth dielectric layer 128 may be exactly the same as, partially different from, or completely different from the materials of the first dielectric layer 116 and the second dielectric layer 120. For example, the third dielectric layer 124 includes the material different from those of the first dielectric layer 116 and the second dielectric layer 120, while the fourth dielectric layer 128 includes the material the same as that of the first dielectric layer 116. In some embodiments, the third dielectric layer 124 and the fourth dielectric layer 128 respectively include the materials with a refractive index between about 1.2 and about 3.

In some embodiments, lateral feature dimensions FD (such as widths, diameters, or equivalent diameters) of the first portions 114, the second portions 118, the third portions 122, and the fourth portions 126 are between about 30 nanometers (nm) and about 450 nm. In some embodiments, heights of the first portions 114, the second portions 118, the third portions 122, and the fourth portions 126 are between about 200 nm and about 1000 nm. In some embodiments, a ratio of the height to the width of each of the first portions 114, the second portions 118, the third portions 122, and the fourth portions 126 is between about 1 and about 8.

Each of the first portions 114 and the second portion 118, the third portion 122, and the fourth portion 126 stacked vertically above it together constitute a meta-atom 110, which is configured to modulate the phase, amplitude, and/or polarization of electromagnetic waves through its subwavelength geometry structure. In some embodiments, a ratio of a height to a width of the each meta-atom 110 may be greater than 10. The first dielectric layer 116, the second dielectric layer 120, the third dielectric layer 124, and the fourth dielectric layer 128 together constitute a dielectric structure 112 over the substrate structure 100. As a result, the meta-atoms 110 are disposed within the dielectric structure 112, for example, in an array, to form a meta-lens ML.

Geometric shapes of each layer of the meta-atom 110 can be adjusted depending on the electromagnetic behavior desired to be achieved. Each layer of the meta-atom 110 may have the same or different cross-sectional profiles, such as circular, square, or cross-shaped, etc. For example, in some other embodiments, each of the first portions 114 has a square cross-sectional profile, while each of the second portions 118 has a circular cross-sectional profile, as shown in FIGS. 6A and 6B. In these embodiments, the orthographic projection area of each of the second portions 118 onto the substrate structure 100 completely overlaps with the orthographic projection area of the corresponding first portion 114 onto the substrate structure 100. Hence, according to the definition of "overlap ratio" in the present disclosure, the overlap ratio of the orthographic projection area of the second portion 118 to the orthographic projection area of the first portion 114 is about π/4. In some embodiments, the ratio of overlap between the orthographic projection areas of two top-down adjacent portions of the meta-atom 110 is between about 0.3 and about 1.

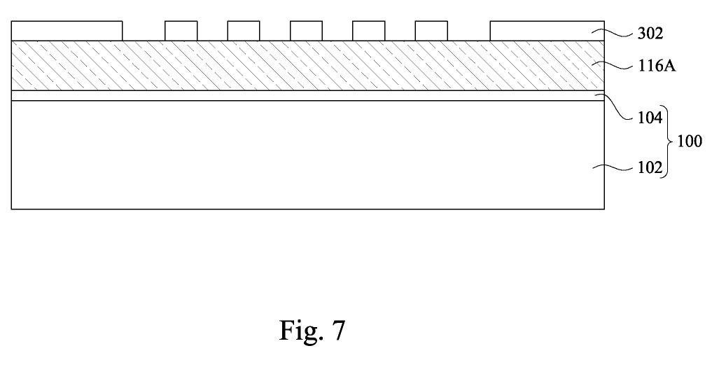

A description is provided with reference to FIGS. 7-11, which illustrate cross-sectional views of various stages of a method for forming an optical module 10A according to some other embodiments of the present disclosure. It is noted that, since part of structures and process steps in FIGS. 7-11 are the same as or similar to those shown in FIGS. 1-5, only the different parts will be explained in the following and repeated content is not provided.

As shown in FIG. 7, the first dielectric material 116A is first deposited over the substrate structure 100. Then, a mask layer 302 is formed over the first dielectric material 116A. The mask layer 302 has a second pattern after being patterned. The second pattern is complementary to the first pattern described in FIG. 1.

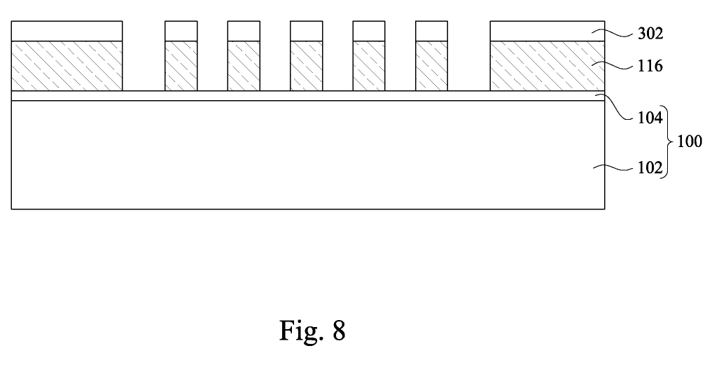

As shown in FIG. 8, a patterning process, such as etching, is performed on the first dielectric material 116A through the mask layer 302 until a top surface of the substrate structure 100 is exposed. As a result, the second pattern that the mask layer 302 has is transferred into the first dielectric material 116A. The patterned first dielectric material 116A forms the first dielectric layer 116 having a plurality of first trenches. The top surface of the substrate structure 100 is exposed through the first trenches. As shown in FIG. 2, dimensions of these trenches can vary depending on the defined second pattern. For example, a width of the first one of the first trenches on the left and a width of the first one of the first trenches on the right can be greater than a width of the four first trenches in the middle.

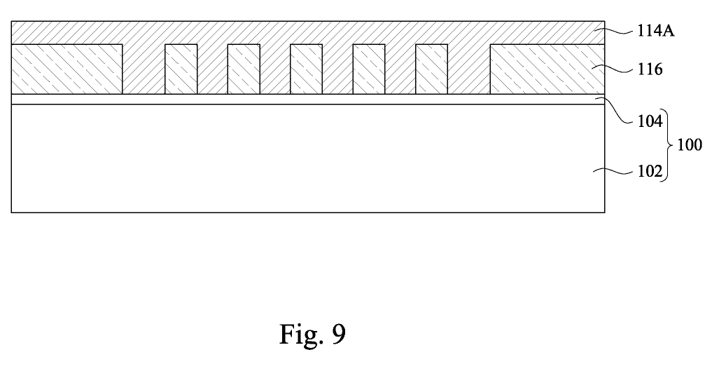

As shown in FIG. 9, the mask layer 302 is removed from the first dielectric layer 116 to expose a top surface of the first dielectric layer 116. Next, the first metamaterial layer 114A is deposited covering the first dielectric layer 116 and filling each of the first trenches.

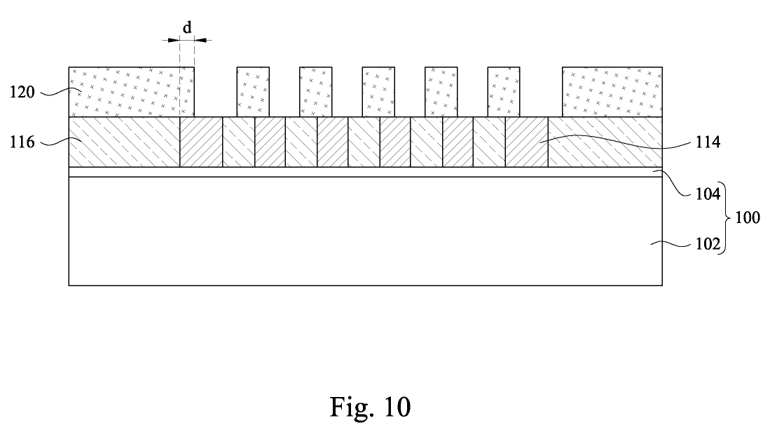

As shown in FIG. 10, a planarization process, such as chemical mechanical polishing (CMP), is performed on the first metamaterial layer 114A to expose the top surface of the first dielectric layer 116, thus forming the first portions 114 separated from one another in the first trenches of the first dielectric layer 116. These first portions 114 form a plurality of subwavelength structures. In some embodiments, the planarization process is performed such that the top surface of the first dielectric layer 116 is substantially flush with top surfaces of the first portions 114. After that, the second dielectric layer 120 is formed over the first dielectric layer 116 and the first portions 114. The formation of the second dielectric layer 120 can adopt a process similar to that used to form the first dielectric layer 116. For example, a second dielectric material is deposited over the first portions 114 and the first dielectric layer 116, and a patterning process is performed on the second dielectric material through a mask layer to form a plurality of second trenches. The patterned second dielectric material forms the second dielectric layer 120 having the second trenches. Each of the second trenches at least partially exposes the top surface of one of the first portions 114. It is noted that, the second dielectric layer 120 may have the same pattern as the first dielectric layer 116 but offset to the right. For example, as shown in FIG. 10, the pattern of the second dielectric layer 120 is offset to the right by a distance d relative to the pattern of the first dielectric layer 116. In other words, the second dielectric layer 120 exposes part of the top surfaces of the first portions 114 and part of the top surface of the first dielectric layer 116. In these embodiments, the second dielectric layer 120 overlaps with each of the first portions 114. In some embodiments, the second dielectric layer 120 may contact each of the first portions 114.

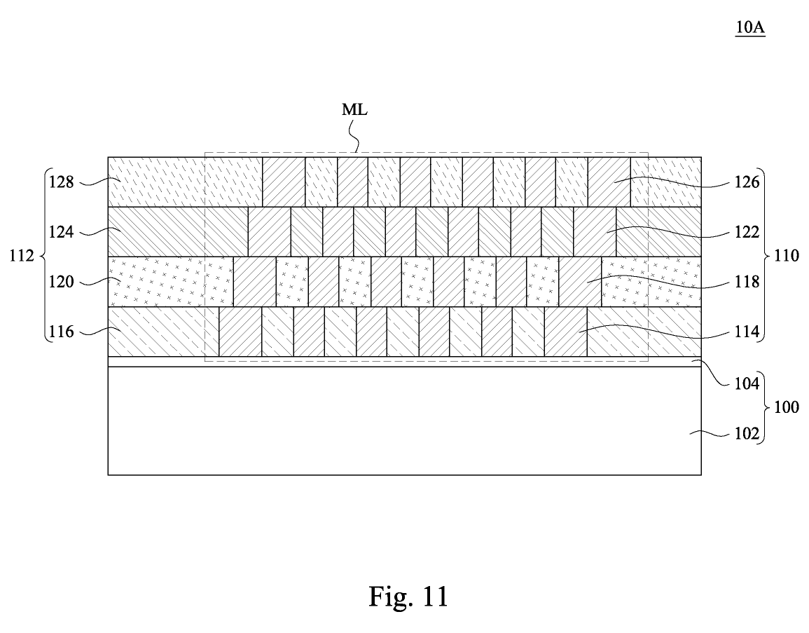

As shown in FIG. 11, a second metamaterial layer is deposited covering the second dielectric layer 120 and filling the second trenches. Then, a planarization process is performed on the second metamaterial layer to expose a top surface of the second dielectric layer 120, thus forming the second portions 118 separated from one another in the second trenches of the second dielectric layer 120. These second portions 118 form a plurality of subwavelength structures. The second portions 118 respectively correspond to the first portions 114, and each of the second portions 118 is offset to the right by the distance d relative to its corresponding first portion 114. In these embodiments, an orthographic projection area of each of the second portions 118 onto the substrate structure 100 at least partially overlaps with an orthographic projection area of its corresponding first portion 114 onto the substrate structure 100. Similarly, a ratio of overlap between the orthographic projection areas of the second portion 118 and the first portion 114 onto the substrate structure 100 is between about 0.3 and about 1. For example, in the embodiment corresponding to FIG. 11, the ratio of overlap between the orthographic projection areas of the second portion 118 and the first portion 114 is between about 0.5 and about 0.8.

Next, the third portions 122, the third dielectric layer 124 laterally surrounding the third portions 122, the fourth portions 126, and the fourth dielectric layer 128 laterally surrounding the fourth portions 126 are formed in a similar manner. As shown in the figure, the third portions 122 respectively correspond to the second portions 118, and each of the third portions 122 is offset to the right relative to its corresponding second portion 118. An orthographic projection area of each of the third portions 122 onto the substrate structure 100 at least partially overlaps with the orthographic projection area of its corresponding second portion 118 onto the substrate structure 100. In some embodiments, an overlap ratio between the third portion 122 and its corresponding second portion 118 is between about 0.3 and about 1. The fourth portions 126 respectively correspond to the third portions 122, and each of the fourth portions 126 is offset to the right relative to its corresponding third portion 122. An orthographic projection area of each of the fourth portions 126 onto the substrate structure 100 at least partially overlaps with the orthographic projection area of its corresponding third portion 122 onto the substrate structure 100. In some embodiments, an overlap ratio between the fourth portion 126 and its corresponding third portion 122 is between about 0.3 and about 1.

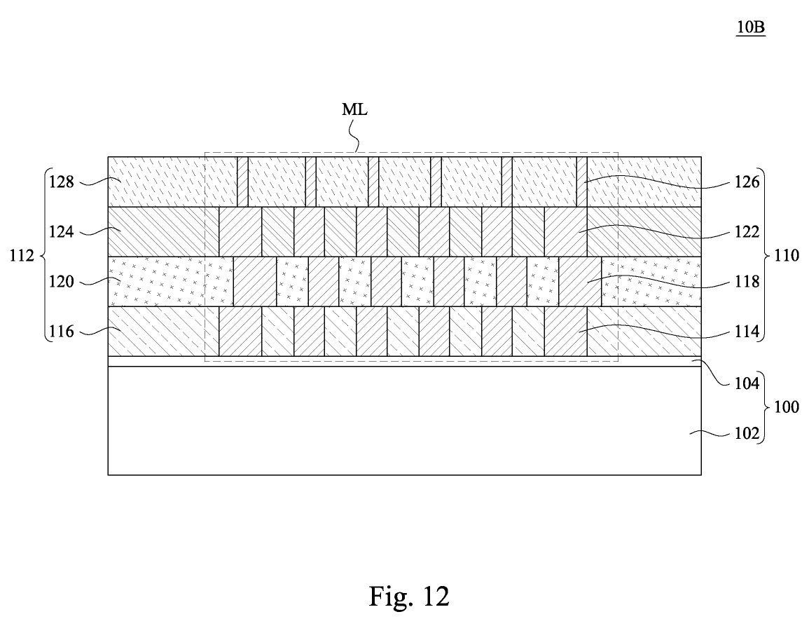

A description is provided with reference to FIG. 12, which illustrates a cross-sectional view of an optical module 10B according to some other embodiments of the present disclosure. One of the differences between the optical module 10B and optical module 10 lies in that the second portions 118 of optical module 10B are offset to the right relative to the first portions 114, and the third portions 122 are not offset relative to the first portions 114. In addition to that, a width of each of the fourth portions 126 is smaller than a width of each of the third portions 122, and each of the fourth portions 126 is located directly above its corresponding third portion 122. In these embodiments, an overlap ratio of an orthographic projection area of the fourth portion 126 to an orthographic projection area of its corresponding third portion 122 is between about 0.3 and about 0.5, but the present disclosure is not limited thereto. In addition, under the circumstance that the third portion 122 and the first portion 114 have the same cross-sectional profile, the orthographic projection area of the third portion 122 onto the substrate structure 100 completely overlaps with an orthographic projection area of the first portion 114 onto the substrate structure 100. In other words, an overlap ratio between the third portion 122 and the first portion 114 is about 1.

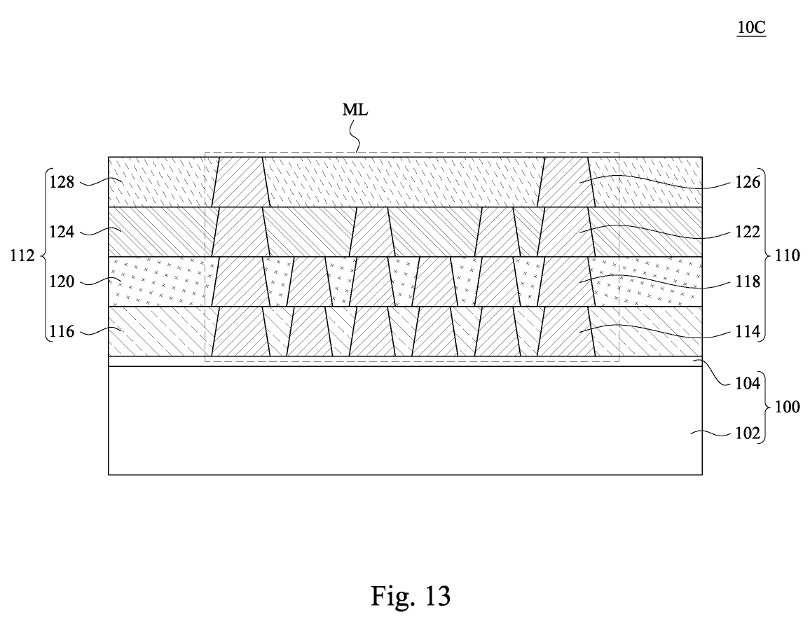

A description is provided with reference to FIG. 13, which illustrates a cross-sectional view of an optical module 10C according to some other embodiments of the present disclosure. One of the differences between the optical module 10C and optical module 10 lies in that cross-sectional profiles of the first portion 114, the second portion 118, the third portion 122, and the fourth portion 126 of the optical module 10C are trapezoidal, so that their cross-sectional areas respectively decrease upwards along a direction perpendicular to the substrate structure 100. As a result, the overlapping areas and/or contact areas between two top-down adjacent portions are increased to reduce the interface discontinuities caused by process variations so as to maintain the optical uniformity and stability of the structure.

Additionally, as shown in FIG. 13, a number of the third portions 122 is less than a number of the second portions 118, and a number of the fourth portions 126 is less than the number of the third portions 122 and the number of the second portions 118. In other words, in the optical module 10C part of meta-atoms only include the first portions 114 and the second portions 118, part of the meta-atoms only include the first portions 114, the second portions 118, and the third portions 122, and the other part of the meta-atoms include the first portions 114, the second portions 118, the third portions 122, and the fourth portions 126. Similarly, in one meta-atom orthographic projection areas of two top-down adjacent portions at least partially overlap with each other, and an overlap ratio is between about 0.3 and about 1. As a result, the meta-atoms in the one meta-lens ML can have different heights to increase the degree of freedom in longitudinal design.

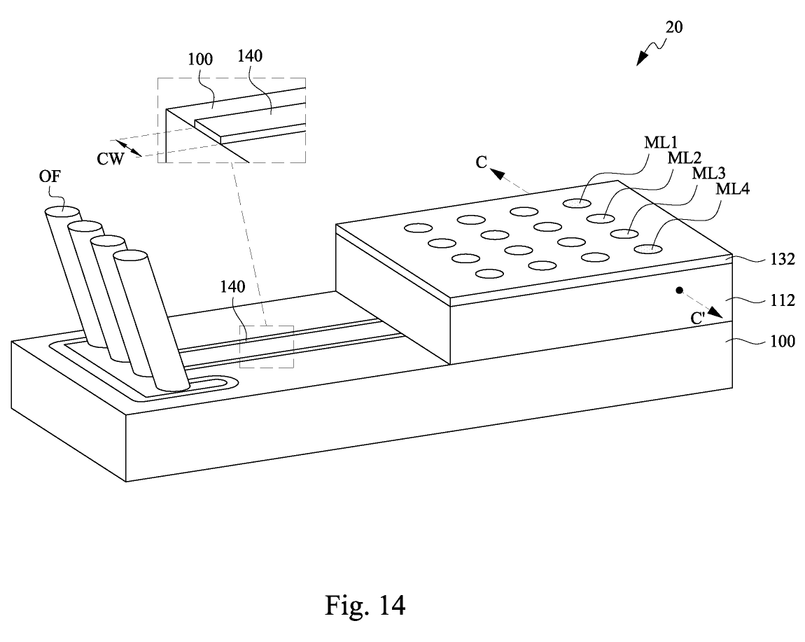

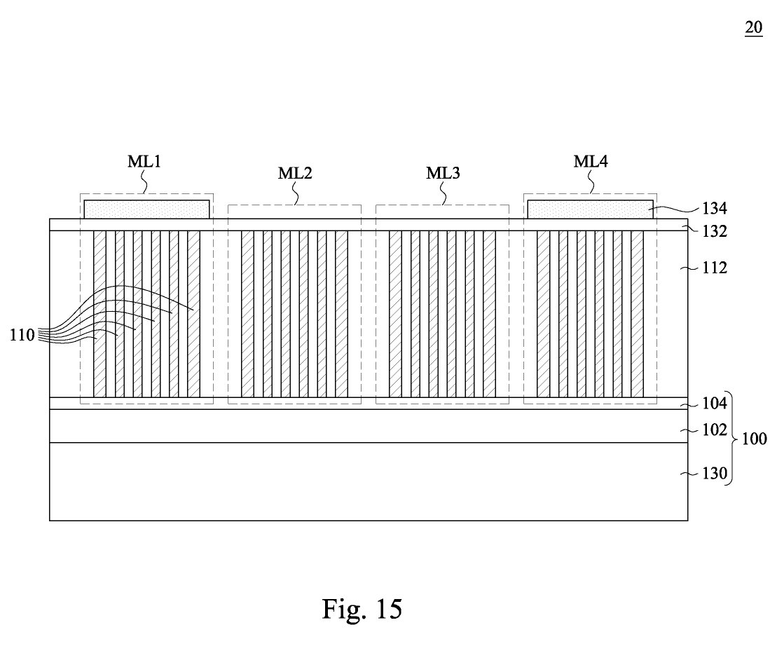

A description is provided with reference to FIGS. 14 and 15. FIG. 14 illustrates a schematic perspective view of an optical module 20 according to some other embodiments of the present disclosure. FIG. 15 illustrates a cross-sectional view of the optical module 20 taken along line C-C' in FIG. 14. It is noted that, since the structure of the optical module 20 is the same as or similar to part of the structures of the previously-mentioned optical modules, only the different parts will be explained in the following and repeated content is not provided.

The optical module 20 includes the substrate structure 100 and a meta-lens array structure over the substrate structure 100. For example, the meta-lens array structure includes a meta-lens ML1, a meta-lens ML2, a meta-lens ML3, and a meta-lens ML4.

The substrate structure 100 includes a silicon photonic chip (SiPh) 130. The silicon photonic chip 130 includes an optical waveguide, such as a waveguide 140, and is coupled to optical fibers (OF). The waveguide 140 is configured to couple an optical signal from the optical fiber OF to the meta-lens array structure. In some embodiments, a core width CW of a core of the waveguide 140 may be less than about 150 micrometers. To be more specific, the core width CW may be between about 100 nm and about 2 μm.

The meta-lens array structure includes a dielectric structure 112 and a plurality of meta-atoms 110. The dielectric structure 112 is over the substrate structure 100. The meta-atoms 110 are located within the dielectric structure 112. The meta-atoms 110 and the dielectric structure 112 of the optical module 20 are similar to those of the optical module 10, and therefore detailed descriptions are omitted herein.

As shown in FIG. 15, in some embodiments, the substrate structure 100 further includes a substrate 102 over the silicon photonic chip 130. In some embodiments, the substrate 102 may include silicon, glass, optical resin, optical plastic, or a combination thereof. In some embodiments, the substrate structure 100 further includes an anti-reflective layer 104 over the substrate 102 to reduce interface reflection loss and improve transmission efficiency.

Correspondingly, to enable coupling between the optical waveguide included in the silicon photonic chip 130 and the meta-lens array structure, the method for forming the optical module 20 further includes disposing the optical waveguide such that it is coupled to the meta-lens array structure, in which the meta-lens array structure is configured to receive an optical signal from the optical waveguide. The provision of the optical waveguide may be implemented through at least two different embodiments. In the embodiment where the substrate structure 100 includes the substrate 102, the method may include forming the dielectric structure 112 and the meta-atoms 110 over the substrate 102, and then transferring and bonding the substrate 102 onto the silicon photonic chip 130 such that the meta-atoms 110 are coupled to the optical waveguide of the silicon photonic chip 130. In the embodiment where the substrate structure 100 does not include the substrate 102, the method may include directly forming the dielectric structure 112 and the meta-atoms 110 over the silicon photonic chip 130 such that the meta-atoms 110 are directly coupled to the optical waveguide of the silicon photonic chip 130.

In some embodiments, the substrate structure 100 further includes an anti-reflective layer 132 covering the meta-atoms 110 and the dielectric structure 112 to reduce interface reflection loss and improve transmission efficiency. In some embodiments, the anti-reflective layer 132 includes silicon oxide (SiO), silicon nitride (SiN), titanium oxide (TiO), hafnium oxide (HfO), tantalum oxide (TaO), or a combination thereof.

In some embodiments, the substrate structure 100 further includes reflective structures 134 partially covering the anti-reflective layer 132. In some embodiments, the reflective structures 134 are deposited thin metal films. A material of the reflective structures 134 may include aluminum (Al), copper (Cu), gold (Au), silver (Ag), or a combination thereof. The thin metal film has broadband reflectivity to be able to achieve a reflectivity of about 80% to about 90% in the visible to near-infrared band.

Correspondingly, the method for forming the optical module 20 further includes forming the anti-reflective layer 132 covering the meta-atoms 110 and the dielectric structure 112 after forming the meta-atoms 110 and the dielectric structure 112. Then, the reflective structures 134 are formed over the anti-reflective layer 132 and cover part of a top surface of the anti-reflective layer 132. In the embodiment where each of the meta-atoms 110 at least includes a first portion and a second portion, the reflective structures 134 are formed over the second portion of at least one of the meta-atoms 110.

The above structure forms the meta-lens ML1, the meta-lens ML2, the meta-lens ML3, and the meta-lens ML4 as shown in the figure. The meta-lens ML1 and the metal-lens ML4 include the reflective structures 134, and the metal-lens ML2 and the meta-lens ML3 do not have the reflective structure. As a result, a dual-mode meta-lens array structure that can simultaneously achieve transmission and reflection functions is formed, thus allowing it to perform both normal optical operation and alignment correction functions at the same time.

In greater detail, the meta-lenses that do not have the reflective structure, such as the meta-lens ML2 and the meta-lens ML3, are used for normal optical operation. On the contrary, the meta-lens ML1 and the meta-lens ML4 that have reflection function can be used to assist in the optical alignment between the meta-lens array structure and the silicon photonic chip 130. For example, optical signals from the optical fibers OF are transmitted through the optical waveguide, such as the waveguide 140, of the silicon photonic chip 130 to the meta-lens ML1 and the meta-lens ML4. After passing through the meta-atoms 110 in the meta-lens ML1 and the meta-lens ML4, the optical signals reach the reflective structures 134 and are reflected back to the optical fibers OF by the reflective structures 134. Ends of the optical fibers OF can be disposed with photodetectors or power meters to receive and measure intensities of returned lights. In this manner, whether optical axes of the meta-lens ML1 and the meta-lens ML4 are aligned with the silicon photonics chip 130 or not is determined. The higher the light intensity is, the more accurate the alignment is. A decrease in light intensity indicates the existence of misalignment. In some other embodiments, the silicon photonic chip 130 can be further integrated with an optical splitter and photodetectors, which allows the reflected optical signals to be distributed to different photodetectors within the chip for multi-point alignment or directional misalignment analysis to improve alignment accuracy. This alignment method can achieve automatic correction and channel-level feedback by using reflected optical signals, without relying on imaging systems or mechanical scanning and manual adjustments. At the same time, the meta-lens array structure including the metal reflective layer formed by the above method can be fabricated through common thin film deposition and lithography processes, which can be integrated into standard CMOS processes and has high potential for mass production.

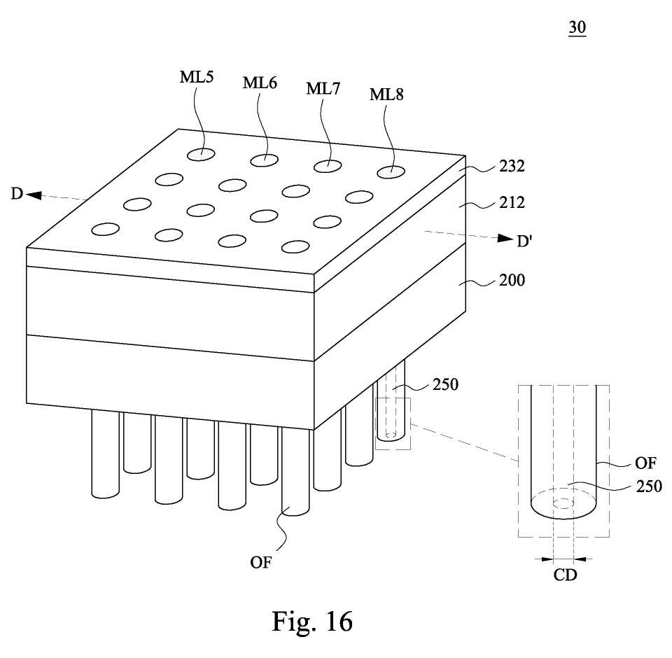

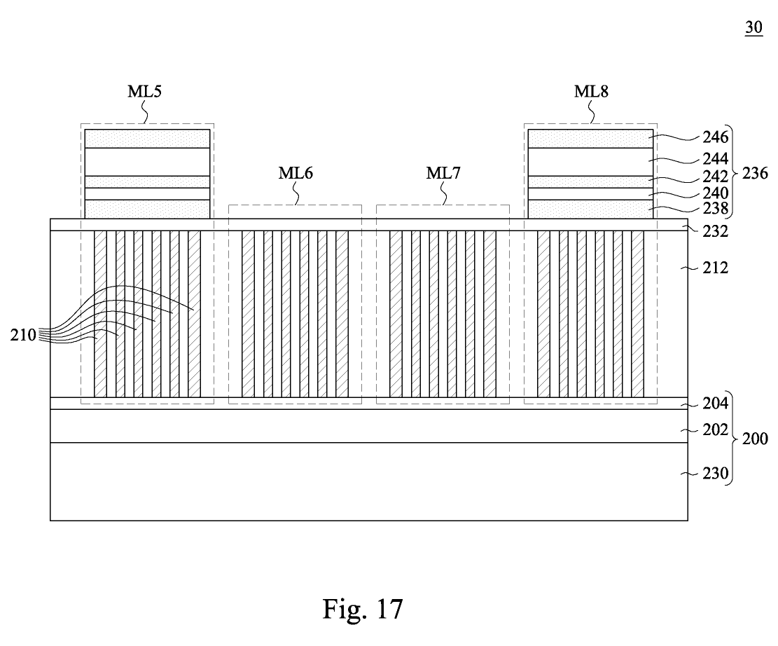

A description is provided with reference to FIGS. 16 and 17. FIG. 16 illustrates a schematic perspective view of an optical module 30 according to some other embodiments of the present disclosure. FIG. 17 illustrates a cross-sectional view of the optical module 30 taken along line D-D' in FIG. 16.

The optical module 30 includes a substrate structure 200 and a meta-lens array structure located over the substrate structure 200. For example, the meta-lens array structure includes a meta-lens ML5, a meta-lens ML6, a meta-lens ML7, and a meta-lens ML8.

The substrate structure 200 includes a fiber array unit 230 (FAU). The fiber array unit 230 includes a plurality of optical waveguides, such as optical fibers OF, arranged at a fixed spacing to form a fiber array. The optical fibers OF are configured to couple optical signals to the meta-lens array structure. In some embodiments, a core 250 of each optical fiber OF may have a core diameter CD of less than about 150 micrometers (μm). To be more specific, the core diameter CD may be between about 5 μm and about 70 μm.

The meta-lens array structure includes a dielectric structure 212 and a plurality of meta-atoms 210. The dielectric structure 212 is over the substrate structure 200. The meta-atoms 210 are located within the dielectric structure 212. The meta-atoms 210 and the dielectric structure 212 of the optical module 30 are similar to the meta-atoms 110 and the dielectric structure 112 of the optical module 10, and therefore detailed descriptions are omitted herein.

As shown in FIG. 17, in some embodiments, the substrate structure 200 further includes a substrate 202 over the fiber array unit 230. In some embodiments, the substrate structure 200 further includes an anti-reflection layer 204 over the substrate 202 to reduce interface reflection loss and improve transmission efficiency. The substrate 202 and the anti-reflection layer 204 are similar to the substrate 102 and the anti-reflection layer 104 of the optical module 20, and thus are not described in detail herein.

Correspondingly, to enable coupling between the optical waveguides included in the fiber array unit 230 and the meta-lens array structure, the method for forming the optical module 30 further includes disposing the optical waveguides such that they are coupled to the meta-lens array structure, in which the meta-lens array structure is configured to receive optical signals from the optical waveguides. The provision of the optical waveguides may be implemented through at least two different embodiments. In the embodiment where the substrate structure 200 includes the substrate 202, the method may include forming the dielectric structure 212 and the meta-atoms 210 over the substrate 202, and then transferring and bonding the substrate 202 onto the fiber array unit 230 such that the meta-atoms 210 are coupled to the optical waveguides of the fiber array unit 230. In the embodiment where the substrate structure 200 does not include the substrate 202, the method may include directly forming the dielectric structure 212 and the meta-atoms 210 over the fiber array unit 230 such that the meta-atoms 210 are directly coupled to the optical waveguides of the fiber array unit 230.

In some embodiments, the substrate structure 200 further includes an anti-reflective layer 232 covering the meta-atoms 210 and the dielectric structure 212. Since the anti-reflective layer 232 is similar to the anti-reflective layer 132 of the optical module 20, a description in this regard is not provided here.

In some embodiments, the substrate structure 200 further includes reflective structures 236 partially covering the anti-reflective layer 232. In some embodiments, each of the reflective structures 236 includes a dielectric layer 238, a dielectric layer 240, a dielectric layer 242, a dielectric layer 244, and a dielectric layer 246 that are vertically stacked. Top-down adjacent dielectric layers adopt different materials, thicknesses, and refractive indices to form a Bragg reflector, so that the reflective structures 236 can achieve a high reflectivity of about 99.9% within a specific narrow wavelength band. The reflective structures 236 can also be applied to the optical module 20.

Correspondingly, the method for forming the optical module 30 further includes forming the anti-reflective layer 232 covering the meta-atoms 210 and the dielectric structure 212 after forming the meta-atoms 210 and the dielectric structure 212. Then, the reflective structures 236 are formed over the anti-reflective layer 232 and cover part of a top surface of the anti-reflective layer 232. In the embodiment where each of the meta-atoms 210 at least includes a first portion and a second portion, the reflective structures 236 are formed over the second portion of at least one of the meta-atoms 210.

The above structure forms the meta-lens ML5, the meta-lens ML6, the meta-lens ML7, and the meta-lens ML8 as shown in the figure. Similarly, the meta-lens ML5 and the metal-lens ML8 include the reflective structures 236, and the metal-lens ML6 and the meta-lens ML7 do not have the reflective structure. As a result, a dual-mode meta-lens array structure that can simultaneously achieve transmission and reflection functions is formed. The meta-lenses that do not have the reflective structure, such as the meta-lens ML6 and the meta-lens ML7, are used for normal optical operation. The meta-lens ML5 and the meta-lens ML8 that have reflection function are used to assist in the optical alignment between the meta-lens array structure and the fiber array unit 230.

In greater detail, the optical fibers OF can output part of optical signals. This part of optical signals are transmitted to the meta-lens ML5 and the meta-lens ML8. After passing through the meta-atoms 210 in the meta-lens ML5 and meta-lens ML8, the optical signals reach the reflective structures 236 and are reflected back to the optical fibers OF by the reflective structures 236. Ends of the optical fibers OF can be disposed with photodetectors to receive and measure intensities, distributions, or time changes of returned lights. In this manner, whether a relative position between the meta-lens array structure and the fiber array unit 230 is deviated or not is determined. When optical axes of the two are aligned, the light intensities are higher. If there is a lateral displacement, an angular deviation, or a height error, the light intensities will decrease. As a result, by measuring changes of the returned lights, a quantifiable alignment index can be established to guide position adjustment during the packaging process.

In some other embodiments, the fiber array unit 230 can output multiple sets of optical signals, and use reflective meta-lenses at different positions (such as the meta-lens ML5 and the meta-lens ML8) to perform multi-point return detection so as to simultaneously determine deviations in different coordinate axis directions to further improve the alignment accuracy.

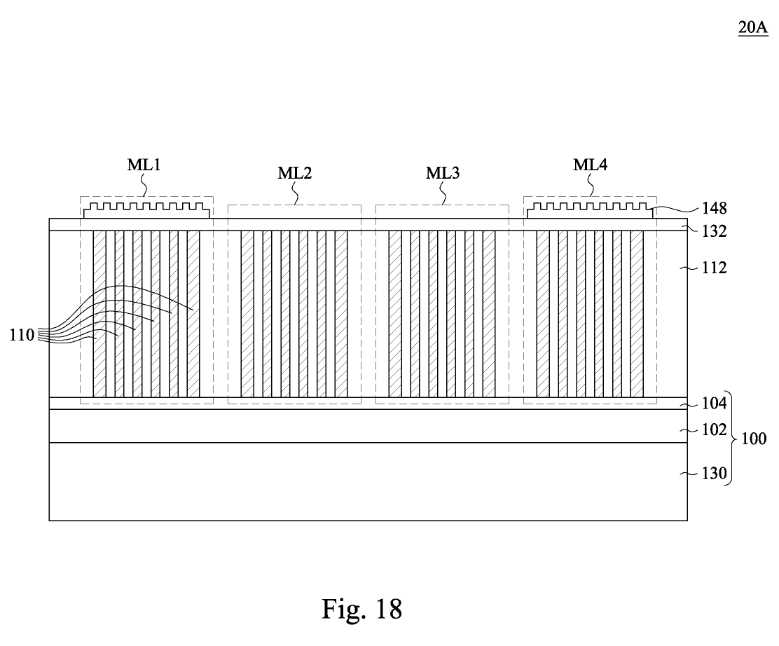

A description is provided with reference to FIG. 18. FIG. 18 illustrates a cross-sectional view of an optical module 20A according to some other embodiments of the present disclosure. One of the differences between the optical module 20A and optical module 20 lies in that the meta-lens ML1 and the meta-lens ML4 of the optical module 20A include reflective structures 148. The reflective structures 148 are reflection grating structures used to generate high reflectivity within a specific wavelength band, such as a guided-mode resonance (GMR) grating or a subwavelength diffraction grating. The guided-mode resonance grating can allow incident light to generate strong resonance reflection within a specific narrow wavelength band so as to achieve an effect close to total internal reflection. The subwavelength diffraction grating can efficiently reflect light within a specific wavelength range through changing the light phase and the effective refractive index. The reflective structures 148 can also be applied to the optical module 30.

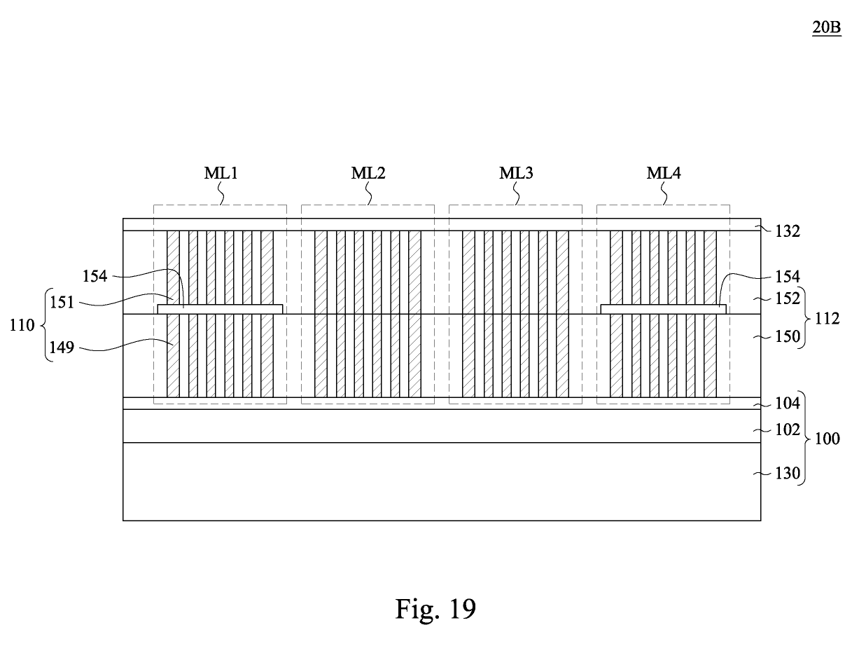

A description is provided with reference to FIG. 19. FIG. 19 illustrates a cross-sectional view of an optical module 20B according to some other embodiments of the present disclosure. One of the differences between the optical module 20B and optical module 20 lies in that reflective structures 154 of the optical module 20B are between upper layers and lower layers of the meta-atoms 110. For example, the meta-atoms 110 of the meta-lens of the optical module 20B include first portions 149 and second portions 151 over the first portions 149. The dielectric structure 112 of the optical module 20B includes a first dielectric layer 150 and a second dielectric layer 152 over the first dielectric layer 150. The reflective structures 154 are located over the first dielectric layer 150 and part of the first portions 149. The second dielectric layer 152 covers the reflective structures 154. Part of the second portions 151 are located over the reflective structures 154 and aligned with their corresponding ones of the first portions 149. The reflective structures 154 are metasurface reflectors with half-reflection (that is, partial reflection and partial transmission) function. In addition to providing reflection function, it can also integrate other special optical effects, such as polarization control, wavefront shaping, beam deflection, etc. By embedding the reflective structures 154 into an intermediate layer of the meta-atoms 110 (such as between the first portions 149 and the second portions 151), multifunctional optical control can be simultaneously achieved while maintaining the ultrathin structure to further enhance the design flexibility and application diversity of the optical module 20B. In some embodiments, the above reflective structures can also be combined in a single meta-lens to achieve the preset reflection wavelength band and reflectivity.

Correspondingly, the method for forming the optical module 20B includes forming the reflective structures 154 over the first dielectric layer 150 and part of the first portions 149 after forming the first portions 149 and the first dielectric layer 150. Then, the second dielectric layer 152 and the second portions 151 are formed. For example, steps for forming the second dielectric layer 152 and the second portions 151 include depositing a second dielectric material covering the reflective structures 154, the first portions 149, and the first dielectric layer 150. Next, patterning is performed to form second trenches in the second dielectric material. Part of the second trenches expose the reflective structures 154, and another part of the second trenches expose the first portions 149. After that, the second portions 151 are formed in the second trenches, so that part of the second portions 151 are over the reflective structures 154 and another part of the second portions 151 are over the first portions 149.

Based on the description of the embodiments of the present disclosure above, it can be obviously understood that in the optical module and the method for forming the optical module according to some embodiments of the present disclosure, the meta-atoms with a high aspect ratio formed by staking different layers can provide a wider range of phase modulation and higher optical efficiency. In addition, by simultaneously configuring the meta-lenses with reflective and transmissive functions in a meta-lens array, during the alignment process, the meta-lenses with the reflective function are used to reflect part of the optical signals from the silicon photonic chip or fiber array unit, and photodetectors are used to measure the intensities of the returned lights to accurately determine the alignment state of the optical axes. As a result, automated sub-micron alignment accuracy can be achieved during the packaging process without the need of external microscopes or manual adjustments. Additionally, the method adopted for forming the optical module can use standard thin film deposition and lithography process, thus possessing high mass production potential and being able to effectively improve the coupling efficiency and packaging reliability of the optical module.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical module, comprising:
a substrate structure comprises an optical waveguide; and
a meta-lens over the substrate structure comprising:
a dielectric structure over the substrate structure; and
a plurality of meta-atoms within the dielectric structure, and each of the meta-atoms comprising a first portion and a second portion over the first portion, wherein an orthographic projection area of the second portion onto the substrate structure at least partially overlaps with an orthographic projection area of the first portion onto the substrate structure,
wherein the meta-lens is configured to receive an optical signal from the optical waveguide.

2. The optical module of claim 1, wherein the dielectric structure comprises a first dielectric layer and a second dielectric layer over the first dielectric layer, wherein a top surface of the first dielectric layer is substantially flush with a top surface of the first portion, and a top surface of the second dielectric layer is substantially flush with a top surface of the second portion.

3. The optical module of claim 2, wherein the first dielectric layer and the second dielectric layer comprise different materials.

4. The optical module of claim 2, wherein a refractive index of the first dielectric layer is less than a refractive index of the first portion, and a refractive index of the second dielectric layer is less than a refractive index of the second portion.

5. The optical module of claim 2, wherein one of the meta-atoms further comprises a residue between the first portion and the second portion, and the residue comprises a same material as the first dielectric layer.

6. The optical module of claim 1, wherein an overlap ratio of the orthographic projection area of the second portion to the orthographic projection area of the first portion is between about 0.3 and about 1.

7. The optical module of claim 1, wherein the second portion and the first portion comprise a material, and a refractive index of the material is between about 1.2 and about 4.

8. The optical module of claim 1, wherein a cross-sectional area of one of the second portion and the first portion decreases upwards along a direction perpendicular to the substrate structure.

9. The optical module of claim 1, wherein the substrate structure comprises a silicon photonic chip, the silicon photonic chip comprises the optical waveguide, the optical waveguide is configured to couple the optical signal to the meta-lens, a core width of the optical waveguide is less than about 150 micrometers, and the meta-lens further comprises a reflective structure, and the reflective structure is over the substrate structure and configured to reflect the optical signal.

10. The optical module of claim 1, wherein the substrate structure comprises a fiber array unit, the fiber array unit comprises the optical waveguide, the optical waveguide is configured to couple the optical signal to the meta-lens, a core diameter of the optical waveguide is less than about 150 micrometers, and the meta-lens further comprises a reflective structure, and the reflective structure is over the substrate structure and configured to reflect the optical signal.

11. The optical module of claim 1, wherein the meta-lens further comprises a reflective structure between the first portion and the second portion of one of the meta-atoms.

12. The optical module of claim 1, wherein a lateral feature dimension of at least one of the first portion and the second portion is between about 30 nm and about 450 nm.

13. The optical module of claim 1, wherein one of the meta-atoms further comprises a third portion over the second portion, wherein an orthographic projection area of the third portion onto the substrate structure at least partially overlaps with the orthographic projection area of the second portion onto the substrate structure.

14. A method for forming an optical module, comprising:
depositing a first metamaterial layer over a substrate structure;
patterning the first metamaterial layer until the substrate structure is exposed to form a plurality of first portions separated from one another and such that the first portions form a plurality of subwavelength structures;
depositing a dielectric material covering the first portions and the substrate structure, wherein a refractive index of the dielectric material is less than a refractive index of the first metamaterial layer;
performing a planarization process on the dielectric material such that a top surface of the planarized dielectric material is substantially flush with a plurality of top surfaces of the first portions;
depositing a second metamaterial layer over the planarized dielectric material;
patterning the second metamaterial layer until the dielectric material is exposed to form a plurality of second portions separated from one another and such that the second portions form a plurality of subwavelength structures, wherein each of the second portions at least partially overlaps with a corresponding one of the first portions; and
forming an optical waveguide, wherein the first portions and the second portions are configured to receive an optical signal from the optical waveguide.

15. The method of claim 14, wherein the second portions and the first portions comprise a material, and a refractive index of the material is between about 1.2 and about 4.

16. The method of claim 14, wherein an orthographic projection area of each of the second portions onto the substrate structure overlaps with an orthographic projection area of the corresponding one of the first portions onto the substrate structure, and a ratio of overlap is between about 0.3 and about 1.

17. The method of claim 14, further comprising forming a reflective structure over one of the second portions.

18. A method for forming an optical module, comprising:
depositing a first dielectric material over a substrate structure;
patterning the first dielectric material to form a plurality of first trenches exposing the substrate structure;
depositing a first metamaterial layer covering the patterned first dielectric material and filling the first trenches;
performing a first planarization process on the first metamaterial layer to form a plurality of first portions separated from one another in the first trenches and such that the first portions form a plurality of subwavelength structures, wherein a plurality of top surfaces of the first portions are substantially flush with a top surface of the patterned first dielectric material;
depositing a second dielectric material over the patterned first dielectric material and the first portions;
patterning the second dielectric material to form a plurality of second trenches;
depositing a second metamaterial layer covering the patterned second dielectric material and filling the second trenches;
performing a second planarization process on the second metamaterial layer to form a plurality of second portions separated from one another in the second trenches and such that the second portions form a plurality of subwavelength structures, and the second portions at least partially overlapping with the first portions; and
forming an optical waveguide, wherein the first portions and the second portions are configured to receive an optical signal from the optical waveguide.

19. The method of claim 18, wherein the first dielectric material and the second dielectric material comprise different materials.

20. The method of claim 18, further comprising:
forming a reflective structure over at least one of the first portions after forming the first portions,
wherein the second dielectric material is deposited covering the reflective structure.
